(19) United States
(12) Patent Application Publication
(10) Pub. No.: US 2024/0034103 A1
(43) Pub. Date: Feb. 1, 2024

(54) PNEUMATIC TIRE

(71) Applicant: Sumitomo Rubber Industries, Ltd., Kobe-shi (JP)

(72) Inventors: Sho MATSUNAMI, Kobe-shi (JP); Naoki YUKAWA, Kobe-shi (JP); Takuya SATO, Kobe-shi (JP)

(73) Assignee: Sumitomo Rubber Industries, Ltd., Kobe-shi (JP)

(21) Appl. No.: 18/227,315

(22) Filed: Jul. 28, 2023

(30) Foreign Application Priority Data
Jul. 29, 2022 (JP) 2022-121202

(51) Int. Cl. B60C 19/00; B60C 11/03

(52) U.S. Cl. CPC B60C 19/002; B60C 11/03; B60C 2011/0339

(57) ABSTRACT

A pneumatic tire can have a tread portion. A sponge-like sound absorbing member can be on an inner surface of the tread portion. The sound absorbing member can have an outer peripheral surface facing outward in a tire radial direction. A plurality of grooves, and a plurality of land portions separated from each other by the plurality of grooves, can be formed in the outer peripheral surface. Each of the plurality of land portions can be attached to the inner surface continuously along a longitudinal direction of the groove.

### CROSS-REFERENCE TO RELATED APPLICATION(S)

The present application claims priority to Japanese patent application JP 2022-121202, filed on Jul. 29, 2022, the entire contents of which is incorporated herein by reference in its entirety.

### BACKGROUND

### Field

The present disclosure relates to a pneumatic tire having a tread portion.

### Background Art

There has conventionally been a known pneumatic tire in which a sound absorbing part is provided on the inner surface of a tread portion in order to reduce road noise. For example, Japanese Laid-Open Patent Publication No. 2019-108034 proposes a pneumatic tire in which protrusions and recesses are formed on the inward surface in the tire radial direction of a sound absorbing part to further reduce road noise.

### SUMMARY

According an aspect of the present disclosure, a pneumatic tire can include a tread portion wherein: a sponge-like sound absorbing member on an inner surface of the tread portion; the sound absorbing member can have an outer peripheral surface facing outward in a tire radial direction; a plurality of grooves, and a plurality of land portions separated from each other by the plurality of grooves, can be formed in the outer peripheral surface; and each of the plurality of land portions can be attached to the inner surface continuously along a longitudinal direction of the groove.

### BRIEF DESCRIPTION OF THE DRAWINGS

FIG. 1 is a cross-sectional view illustrating a pneumatic tire according to one or more embodiments of the present disclosure;

FIG. 2 is a partial perspective view of a sound absorbing member according to one or more embodiments of the present disclosure;

FIG. 3 is an enlarged cross-sectional view perpendicular to a longitudinal direction of a groove of a sound absorbing member according to one or more embodiments of the present disclosure;

FIG. 4 is a development of a sound absorbing member according to one or more embodiments of the present disclosure as viewed from above an outer peripheral surface thereof;

FIG. 5 is a partial cross-sectional view of a pneumatic tire member according to one or more embodiments of the present disclosure;

FIG. 6 is a development of a sound absorbing member according to another embodiment of the present disclosure, as viewed from above an outer peripheral surface thereof;

FIG. 7 is a cross-sectional view of a sound absorbing member according to still another embodiment of the present disclosure;

FIG. 8 is a cross-sectional view of a sound absorbing member according to still another embodiment of the present disclosure; and

FIG. 9 is a cross-sectional view of a sound absorbing member according to still another embodiment of the present disclosure.

### DETAILED DESCRIPTION

According to the inventors' study, heat generated by the tread of pneumatic tires at high speeds may cause a sound absorber to store heat and affect the tread.

Embodiments of the present disclosure have been made in view of the above circumstances, and an object of one or more embodiments of the present disclosure, among multiple objects, can be to provide a pneumatic tire in which a sponge-like sound absorbing member is provided on an inner surface of a tread portion and which can have improved high speed durability.

As a result of having configurations as described herein, the pneumatic tire according to one or more embodiments of the present disclosure can have improved high speed durability.

Hereinafter, an embodiment of the present disclosure will be described in detail with reference to the drawings.

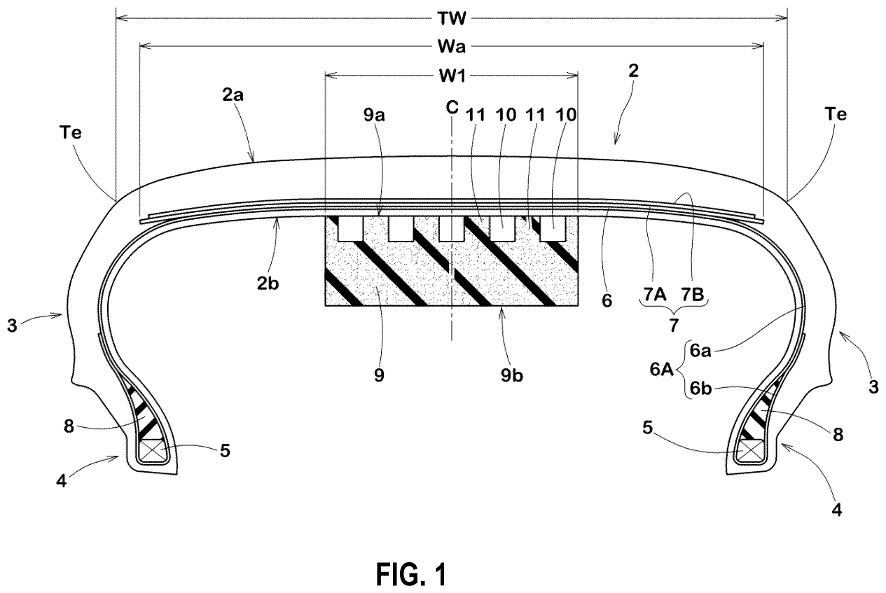

FIG. 1 is a tire meridian cross-sectional view of a pneumatic tire 1 according to one or more embodiments of the present disclosure in a standardized state, including the rotation axis of the pneumatic tire 1. Here, the “standardized state” can be regarded as a state where: the pneumatic tire 1 is fitted on a standardized rim and adjusted to a standardized internal pressure; and no load is applied to the pneumatic tire 1. Hereinafter, unless otherwise specified, dimensions and the like of components of the pneumatic tire 1 are values measured in the standardized state.

If there is a standard system including a standard on which the pneumatic tire 1 is based, the “standardized rim” can be regarded as a rim that is defined for each tire by the standard, and is, for example, the “standard rim” in the JATMA standard, the “Design Rim” in the TRA standard, or the “Measuring Rim” in the ETRTO standard. If there is no standard system including a standard on which the pneumatic tire 1 is based, the “standardized rim” can be regarded as a rim having the smallest rim diameter and having the smallest rim width, among rims to which the pneumatic tire 1 can be fitted and which do not cause air leakage.

If there is a standard system including a standard on which the pneumatic tire 1 is based, the “standardized internal pressure” can be regarded as an air pressure that is defined for each tire by each standard, and is the “maximum air pressure” in the JATMA standard, the maximum value indicated in the table “TIRE LOAD LIMITS AT VARIOUS COLD INFLATION PRESSURES” in the TRA standard, or the “INFLATION PRESSURE” in the ETRTO standard. If there is no standard system including a standard on which the pneumatic tire 1 is based, the “standardized internal pressure” can be regarded as an air pressure that is defined for each tire by the manufacturer or the like.

As shown in FIG. 1, the pneumatic tire 1 according to one or more embodiments of the present disclosure can have a tread portion 2 that extends annularly, a pair of sidewall portions 3 provided on both sides in the tire axial direction of the tread portion 2, and bead portions 4 provided inward of the respective sidewall portions 3 in the tire radial direction.

The tread portion 2 of one or more embodiments of the present disclosure can have an outer surface 2a that forms a ground-contact surface that is brought into contact with a road surface during running. The sidewall portions 3 can extend inward in the tire radial direction from both sides in the tire axial direction of the tread portion 2. For example, a buttress portion can be provided between the tread portion 2 and each sidewall portion 3. Each bead portion 4 can include, for example, a portion that is brought into contact with a rim when the tire 1 is fitted onto the rim. The bead portion 4 of one or more embodiments of the present disclosure can have a bead core 5 that extends annularly. The bead core 5 may be formed of, for example, a steel wire.

The pneumatic tire 1 of one or more embodiments of the present disclosure can have a carcass 6 that extends from the tread portion 2 to the pair of bead portions 4 through the pair of sidewall portions 3, and a belt layer 7 provided outward of the carcass 6 in the tire radial direction in the tread portion 2. The pneumatic tire 1 may have, for example, a band layer that is provided outward of the belt layer 7 in the tire radial direction.

The carcass 6 can extend toroidally between the bead cores 5 of the pair of bead portions 4 through the tread portion 2 and the pair of sidewall portions 3. The carcass 6 can include at least one (e.g., one, or two, or more) carcass ply 6A. The carcass ply 6A of one or more embodiments of the present disclosure can extend on and between the pair of bead portions 4 through the tread portion 2 and the pair of sidewall portions 3.

The carcass ply 6A can include, for example, a body portion 6a that extends from the tread portion 2 to the bead core 5 of the bead portion 4 through the sidewall portion 3, and a turned-up portion 6b that can be connected to the body portion 6a and turned up around the bead core 5 from the inside to the outside in the tire axial direction. Such a carcass 6 can enhance the stiffness of the bead portion 4 and can serve to improve the durability of the pneumatic tire 1.

The belt layer 7 can include one or more (e.g., one, two, or more) belt plies 7A and 7B. The two belt plies 7A and 7B can include, for example, a first belt ply 7A located on the inner side in the tire radial direction, and a second belt ply 7B located outward of the first belt ply 7A in the tire radial direction. Such a belt layer 7 can enhance the stiffness of the tread portion 2 and can serve to improve the durability of the pneumatic tire 1.

The pneumatic tire 1 can have, for example, bead apexes 8 provided in the bead portions 4 and that can extend outward in the tire radial direction. For example, each bead apex 8 can extend outward in the tire radial direction from the bead core 5, between the body portion 6a and the turned-up portion 6b of the carcass 6. Such a bead apex 8 can enhance the stiffness of the bead portion 4 and can serve to improve the durability of the pneumatic tire 1.

The pneumatic tire 1 of one or more embodiments of the present can have a sponge-like sound absorbing member 9 on an inner surface 2b in the tire radial direction of the tread portion 2. Put another way, the sound absorbing member 9 can have qualities typically associated with a sponge, for instance, porousness, compression and expansion properties, etc. (in addition to sound absorbing properties). The sound absorbing member 9 can have an outer peripheral surface 9a that faces outward in the tire radial direction, and an inner peripheral surface 9b that faces inward in the tire radial direction. The sound absorbing member 9 of one or more embodiments of the present embodiment can be firmly attached at the outer peripheral surface 9a to the inner surface 2b of the tread portion 2. Examples of the sponge material include ether-based polyurethane, ester-based polyurethane, and polyethylene. Such sound absorbing member 9 can reduce road noise while suppressing weight increase. The sponge material according to one or more embodiments of the disclosed subject matter, however, is not limited to such a mode, and may be, for example, a rubber-based sponge material.

Such sound absorbing member 9 can reduce the road noise of the pneumatic tire 1. Here, the sound absorbing member 9 may be firmly attached to the inner surface 2b by a sticky agent, an adhesive agent, a double-sided tape, or the like, or alternatively, may be fixed to the inner surface 2b by a sealant or the like applied to the inner surface 2b.

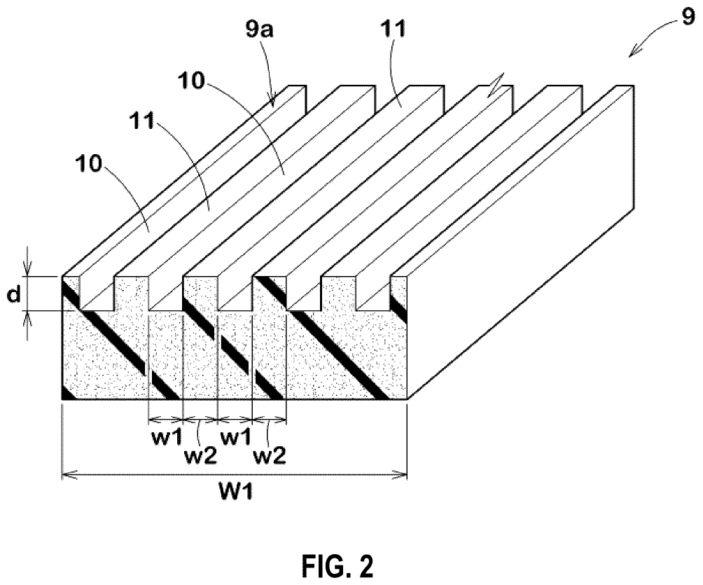

FIG. 2 is a partial perspective view of the sound absorbing member 9. As shown in FIG. 1 and FIG. 2, a plurality of grooves 10, and a plurality of land portions 11a separated from each other by the plurality of grooves 10, are formed in the outer peripheral surface 9a of the sound absorbing member 9 of one or more embodiments of the present disclosure. In the present embodiment shown in FIG. 2, the plurality of land portions 11 can be each firmly attached to the inner surface 2b of the tread portion 2 continuously along a longitudinal direction of the groove 10.

Spaces can be formed between such sound absorbing member 9 and the tread portion 2 by the grooves 10. Therefore, when heat is generated by the tread portion 2, for instance, during high speed running, heat accumulation by the sound absorbing member 9 can be reduced. Therefore, the pneumatic tire 1 according to one or more embodiments of the present disclosure can have improved high speed durability. In addition, when the pneumatic tire 1 has a puncture, the sound absorbing member 9 can allow a puncture repair material to be fed to a puncture area through the groove 10, resulting in efficient puncture repair.

According to one or more embodiments, the attached area of the plurality of land portions 11 to the inner surface 2b can be 25% to 50% of the projected area of the sound absorbing member 9 onto the inner surface 2b, for instance, such as from 27.5% to 47.5% or from 30% to 45%. As the attached area may be not less than 25% of the projected area, then even when the tread portion 2 becomes deformed (e.g., significantly deformed), for instance, during high speed running, the coming off of the sound absorbing member 9 can be suppressed, which can lead to an improvement in the high speed durability of the pneumatic tire 1. As the attached area may be not greater than 50% of the projected area, the heat accumulation of the sound absorbing member 9, for instance, during high speed running, can be reliably reduced, which can lead to an improvement in the high speed durability of the pneumatic tire 1.

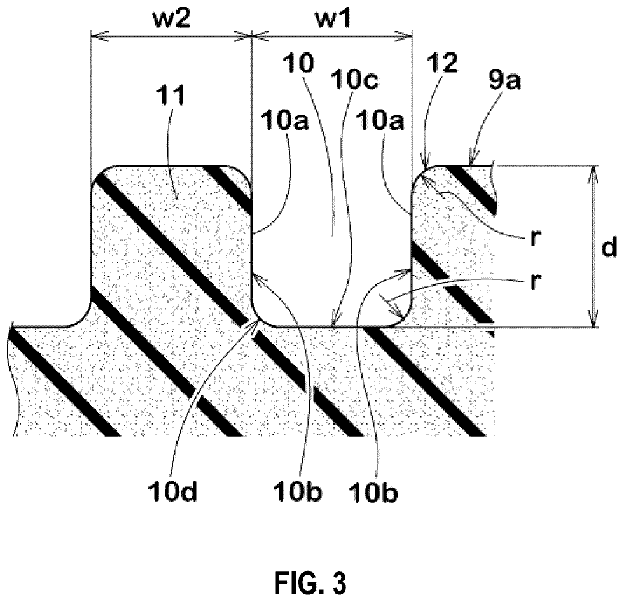

FIG. 3 is an enlarged cross-sectional view perpendicular to the longitudinal direction of the groove 10 according to one or more embodiments of the present disclosure. As shown in FIG. 2 and FIG. 3, the plurality of grooves 10 can have the same cross-sectional shape in a cross-section thereof perpendicular to the longitudinal direction of the groove 10. That is, the plurality of grooves 10 can have groove widths w1 which are equal to each other. Such a sound absorbing member 9 can reduce non-uniformity in a direction perpendicular to the longitudinal direction, and therefore can improve the noise performance of the pneumatic tire 1 in a well-balanced manner.

The plurality of land portions 11 can be firmly attached to the inner surface 2b of the tread portion 2 over widths w2 which are equal to each other, in a cross-section thereof perpendicular to the longitudinal direction of the groove 10 (as shown in FIG. 1), for instance. The width w2 of each land portion 11 can be equal to the groove width w1 of each groove 10 at the outer peripheral surface 9a. In the case of such sound absorbing member 9, when a single material is cut along the outer peripheral surface 9a and thereby divided into two portions, both of the two portions can be used as the sound absorbing member 9, which can result in a reduction in manufacturing loss.

The groove width w1 of each groove 10 can be 3 to 10 mm at the outer peripheral surface 9a, as an example. As the groove width w1 may be not less than 3 mm, a space can be reliably formed between the groove 10 and the inner surface 2b. Therefore, heat accumulation can be reduced, and efficiency of puncture repair can be improved. As the groove width w1 may be not greater than 10 mm, a force applied to each land portion 11 can be reduced during running, and therefore, the coming off of the sound absorbing member 9 can be suppressed.

Each groove 10 can have a groove depth d of 1 to 10 mm from the outer peripheral surface 9a, as an example. As the groove depth d may be not less than 1 mm, a space can be reliably formed between the groove 10 and the inner surface 2b, and therefore, heat accumulation can be reduced, and efficiency of puncture repair can be improved. From such a viewpoint, in the case where the means for firmly attaching the sound absorbing member 9 is a sticky agent or a double-sided tape, the groove depth d can be not less than 2 mm, as an example. In the case where the sound absorbing member 9 is firmly attached by a sealant, the groove depth d can be not less than 3 mm, as an example. As the groove depth d may be not greater than 10 mm, a decrease in the strength of the land portions 11 due to the formation of the grooves 10 can be reduced, and therefore, the coming off of the sound absorbing member 9 can be suppressed.

As shown in FIG. 3, each groove 10 can have a pair of groove walls 10a. Each groove wall 10a can have a wall surface 10b that is perpendicular to the outer peripheral surface 9a. Such a groove 10 can contribute to both of the attached area and strength.

Each groove 10 can have a bottom surface 10c that connects the pair of wall surfaces 10b. A chamfered portion 10d can be formed at each of corner portions between the wall surfaces 10b and the bottom surface 10c according to one or more embodiments of the present disclosure. The chamfered portion 10d can be formed, for example, in an arc shape in a cross-section thereof perpendicular to the longitudinal direction of the groove 10. Such a groove 10 can reduce a decrease in the strength of the land portion 11 and can serve to suppress the coming off of the sound absorbing member 9.

A chamfered portion 12 can be formed at each of corner portions between the wall surfaces 10b and the outer peripheral surface 9a according to one or more embodiments of the present disclosure. The chamfered portion 12 can be formed, for example, in an arc shape in a cross-section thereof perpendicular to the longitudinal direction of the groove 10. The chamfered portions 10d on the bottom surface 10c and the chamfered portions 12 on the outer peripheral surface 9a can have the same radius of curvature r according to one or more embodiments of the present disclosure. Such a land portion 11 can maintain good strength and serve to suppress the coming off of the sound absorbing member 9.

The radius of curvature r of each of the chamfered portions 10d on the bottom surface 10c and the chamfered portions 12 on the outer peripheral surface 9a can be 0.5 to 2 mm, as an example. As the radius of curvature r may be not less than 0.5 mm, the strength of the land portion 11 can be maintained, and therefore, the coming off of the sound absorbing member 9 due to the deformation of the tread portion 2 during running can be suppressed. As the radius of curvature r may be not greater than 2 mm, a decrease in the attached area of the sound absorbing member 9 can be reduced, which can lead to suppression of the coming off of the sound absorbing member 9.

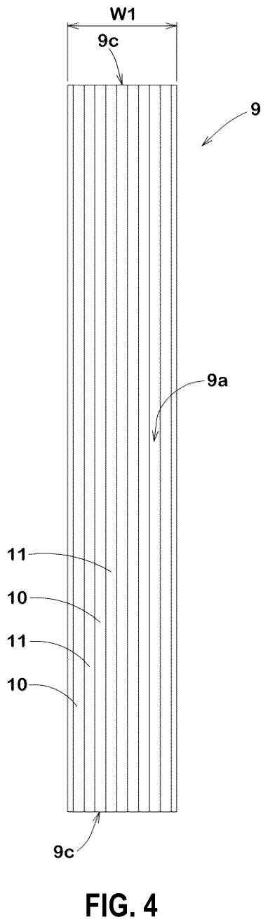

FIG. 4 is a development of the sound absorbing member 9 according to one or more embodiments of the present disclosure as viewed from above the outer peripheral surface 9a. As shown in FIG. 4, each groove 10 can extend in parallel to the tire circumferential direction. The sound absorbing member 9 can have, for example, a pair of end surfaces 9c in the tire circumferential direction. Each groove 10 can be open at the pair of end surfaces 9c. Such a sound absorbing member 9 can have, as examples, one or both of a preferable attached area and a preferable strength, and can reduce heat accumulation of the sound absorbing member 9 and improve efficiency of puncture repair in addition to suppression of the coming off of the sound absorbing member 9.

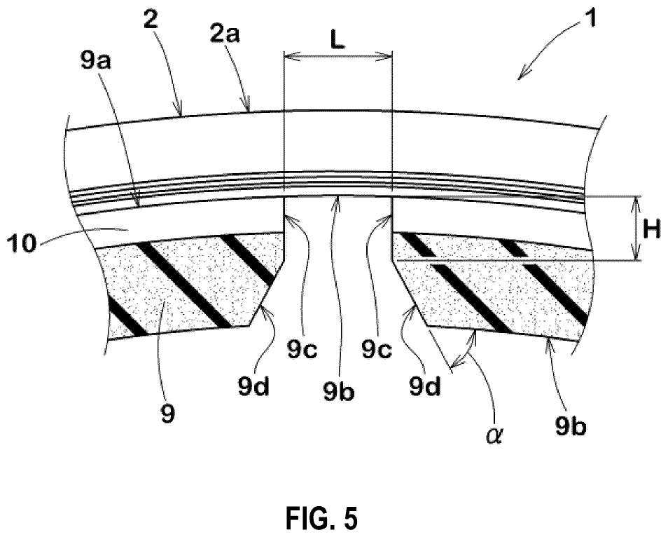

FIG. 5 is a partial cross-sectional view of the pneumatic tire 1 taken at a tire equator C, according to one or more embodiments of the present disclosure. Here, as shown in FIG. 1, the tire equator C can be located at the center position between tread ground-contact ends Te on both sides in the tire axial direction. The tread ground-contact ends Te can be or can be regarded as outermost ground-contact positions in the tire axial direction, for instance, when a standardized load is applied to the pneumatic tire 1 in the standardized state and the tire 1 is brought into contact with a flat surface at a camber angle of 0°. In other words, a tread ground-contact width TW between the tread ground-contact ends Te can be or can be regarded as the maximum width of a ground-contact surface, for instance, when a standardized load is applied to the pneumatic tire 1 in the standardized state.

If there is a standard system including a standard on which the pneumatic tire 1 is based, the “standardized load” can be regarded as a load that is defined for each tire by each standard, and is the “maximum load capacity” in the JATMA standard, the maximum value indicated in the table “TIRE LOAD LIMITS AT VARIOUS COLD INFLATION PRESSURES” in the TRA standard, or the “LOAD CAPACITY” in the ETRTO standard. If there is no standard system including a standard on which the pneumatic tire 1 is based, the “standardized load” can be regarded as a load that is defined for each tire by the manufacturer or the like.

As shown in FIG. 5, a space L can be formed between the pair of end surfaces 9c of the sound absorbing member 9 firmly attached to the inner surface 2b of the pneumatic tire 1 of the present embodiment. Such a sound absorbing member 9 can allow the puncture repair material to be fed from the end surface 9c of the groove 10, which can result in efficient puncture repair.

The space L between the end surfaces 9c can be 3 to 60 mm, for instance. As the space L may be not less than 3 mm, the puncture repair material can be reliably fed from the end surface 9c of the groove 10. Additionally or alternatively, as the space L may be not greater than 60 mm, non-uniformity in the tire circumferential direction can be reduced, leading to suppression of occurrence of vibrations, noise, and the like during high speed running.

At least one (e.g., in the present embodiment, both) of the pair of end surfaces 9c can have a tapered surface 9d whose height in the tire radial direction may gradually become smaller. The tapered surface 9d can be formed in a flat surface shape, according to one or more embodiments of the present disclosure. The tapered surface 9d may, for example, be formed in an arc shape. The coming off of such sound absorbing member 9 from the end surface 9c, at which stress may be concentrated during running, can be suppressed, which can lead to an improvement in the high speed durability of the pneumatic tire 1.

The tapered surface 9d can be formed in a portion of the end surface 9c. The portion of the end surface 9c in which the tapered surface 9d is not formed can have a height H of 3 to 10 mm, as an example. In such sound absorbing member 9, damage to a sharp portion of the end surface 9c can be reduced, which can lead to an improvement in efficiency of the work of firmly attaching the sound absorbing member 9 to the inner surface 2b of the tread portion 2. It should be noted that the tapered surface 9d may be formed throughout the end surface 9c, for example.

The tapered surface 9d can be inclined at angle α of 30 to 80° with respect to the inner peripheral surface 9b, as an example. As the angle α with respect to the inner peripheral surface 9b may be not less than 30°, the effect of absorbing sound by the sound absorbing member 9 can be maintained at a satisfactory level. As the angle α with respect to the inner peripheral surface 9b may be not greater than 80°, the effect of suppressing the coming off of the sound absorbing member 9 from the end surface 9c can be reliably achieved.

In the pneumatic tire 1 according to one or more embodiments of the present disclosure, the single sound absorbing member 9 can be firmly attached with the space L formed between the pair of end surfaces 9c in the tire circumferential direction. The pneumatic tire 1 according to one or more embodiments of the present disclosure, however, may not be limited to such a mode. Alternatively, in the pneumatic tire 1 according to one or more embodiments of the present disclosure, a plurality of sound absorbing members 9 may be firmly attached with spaces L formed in the tire circumferential direction. In that case, a space L can be formed between the end surfaces 9c of adjacent sound absorbing members 9. For such pneumatic tire 1, the quantity, shape, and the like of the sound absorbing members 9 can be selected, depending on the purpose.

As shown in FIG. 1, a width W1 in the tire axial direction of the sound absorbing member 9 can be smaller than a width Wain the tire axial direction of the belt layer 7. With such sound absorbing member 9, an excessive increase in the weight of the pneumatic tire 1 can be suppressed, which can lead to an improvement in the handling stability of the pneumatic tire 1.

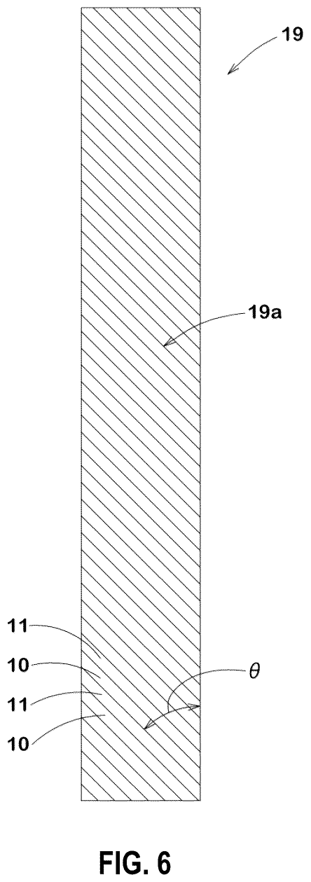

FIG. 6 is a development of a sound absorbing member 19 according to another embodiment as viewed from above an outer peripheral surface 19a thereof. As shown in FIG. 6, a plurality of grooves 10, and a plurality of land portions 11 separated from each other by the plurality of grooves 10, can be formed in the outer peripheral surface 19a of the sound absorbing member 19 of the present embodiment, as in the above-described sound absorbing member 9. In the present embodiment as well, the plurality of land portions 11 can be each firmly attached to the inner surface 2b of the tread portion 2 (e.g., as shown in FIG. 1) continuously along a longitudinal direction of the groove 10.

Each groove 10 of the present embodiment can extends at an angle θ of 1 to 90° with respect to the tire circumferential direction, as an example. In the case where the angle θ of the groove 10 is, for example, about 15 to 45°, the groove 10 can effectively contribute to high speed durability. In the case where the angle θ of the groove 10 is close to 900 (e.g. plus or minus three degrees), the groove 10 can effectively contribute to feeding of the puncture repair material. Therefore, the angle θ of the groove 10 may be 45 to 60°, according to one or more embodiments of the present disclosure. Such sound absorbing member 19 can serve to achieve both high speed durability and efficiency of puncture repair.

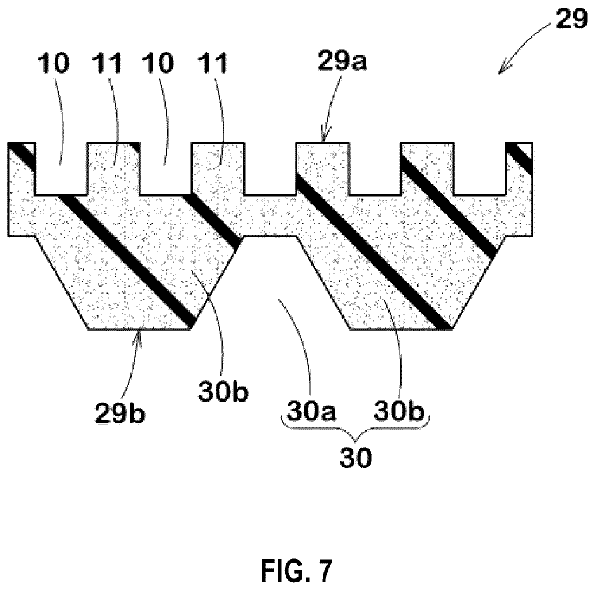

FIG. 7 is a cross-sectional view of a sound absorbing member 29 according to still another embodiment. As shown in FIG. 7, a plurality of grooves 10, and a plurality of land portions 11 separated from each other by the plurality of grooves 10, can be formed in an outer peripheral surface 29a of the sound absorbing member 29 of the present embodiment, as in the above-described sound absorbing member 9. In the present embodiment as well, the plurality of land portions 11 can each be firmly attached to the inner surface 2b of the tread portion 2 (e.g., shown in FIG. 1) continuously along a longitudinal direction of the groove 10.

The sound absorbing member 29 of the present embodiment can have a protrusion-and-recess structure 30 formed in an inner peripheral surface 29b thereof. The protrusion-and-recess structure 30 can include, for example, recesses 30a and protrusions 30b. The protrusion-and-recess structure 30 can be formed independently of the shape of the grooves 10 in the outer peripheral surface 29a. The protrusion-and-recess structure 30 may not be limited to the illustrated form, and may have any shape. The inner peripheral surface 29b of such a sound absorbing member 29 can have a shape advantageous to a reduction in road noise, which can result in a further improvement in noise performance.

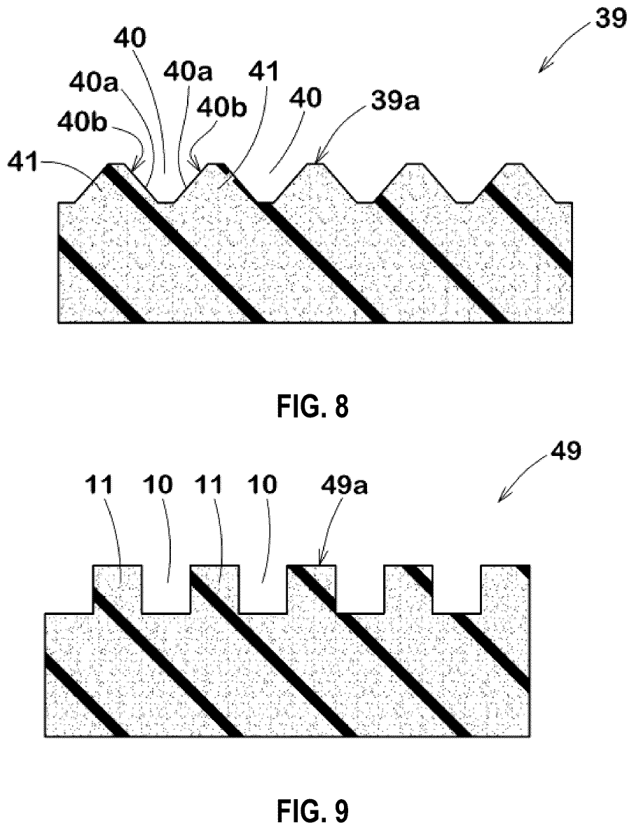

FIG. 8 is a cross-sectional view of a sound absorbing member 39 according to still another embodiment. As shown in FIG. 8, a plurality of grooves 40, and a plurality of land portions 41 separated from each other by the plurality of grooves 40, can be formed in an outer peripheral surface 39a of the sound absorbing member 39 of the present embodiment. In the present embodiment as well, the plurality of land portions 41 can each be firmly attached to the inner surface 2b of the tread portion 2 (e.g., as shown in FIG. 1) continuously along a longitudinal direction of the groove 40.

Each groove 40 of the present embodiment can have a pair of groove walls 40a. Each groove wall 40a of the present embodiment can have a wall surface 40b inclined with respect to the outer peripheral surface 39a. Such groove 40 can enhance the strength of the land portion 41, which can be effective in the case where the sound absorbing member 39 may have a smaller attached area.

FIG. 9 is a cross-sectional view of a sound absorbing member 49 according to still another embodiment. As shown in FIG. 9, a plurality of grooves 10, and a plurality of land portions 11 separated from each other by the plurality of grooves 10, can be formed in an outer peripheral surface 49a of the sound absorbing member 49 of the present embodiment, as in the above-described sound absorbing member 9. In the present embodiment as well, the plurality of land portions 11 can be each firmly attached to the inner surface 2b of the tread portion 2 (e.g., shown in FIG. 1) continuously along a longitudinal direction of the groove 10.

The sound absorbing member 49 of the present embodiment can be asymmetric in a width direction in a cross-section thereof perpendicular to the longitudinal direction of the groove 10. In the case of the sound absorbing member 49, when a single material is cut along the outer peripheral surface 49a and thereby divided into two portions, both of the two portions can be used as the sound absorbing members 49 having the same shape, which can result in a further reduction in manufacturing loss.

Although the particular embodiments have been described in detail above, embodiments of the present disclosure are not limited to the above-described embodiments, and various modifications can be made to implement various embodiments of the present disclosure.

[Additional Note]

Embodiments of the disclosed subject matter can also be as set forth according to the following brackets.
[1]

A pneumatic tire including a tread portion, wherein
a sponge-like sound absorbing member is provided on an inner surface of the tread portion,
the sound absorbing member has an outer peripheral surface facing outward in a tire radial direction,
a plurality of grooves, and a plurality of land portions separated from each other by the plurality of grooves, are formed in the outer peripheral surface, and
each of the plurality of land portions is firmly attached to the inner surface continuously along a longitudinal direction of the groove.
[2]

The pneumatic tire according to [1], wherein an attached area of the plurality of land portions to the inner surface is 25% to 50% of a projected area of the sound absorbing member onto the inner surface.
[3]

The pneumatic tire according to [1] or [2], wherein the plurality of grooves have cross-sectional shapes that are the same as each other, in a cross-section thereof perpendicular to the longitudinal direction of the groove.
[4]

The pneumatic tire according to any one of [1] to [3], wherein
the plurality of land portions are firmly attached to the inner surface over widths that are equal to each other, in the cross-section, and
each of the widths is equal to a groove width of each of the plurality of grooves at the outer peripheral surface.
[5]

The pneumatic tire according to any one of [1] to [4], wherein
each of the plurality of grooves has a pair of groove walls, and
each of the pair of groove walls has a wall surface perpendicular to the outer peripheral surface.
[6]

The pneumatic tire according to any one of [1] to [5], wherein a chamfered portion is formed at each of corner portions between the wall surfaces and the outer peripheral surface.
[7]

The pneumatic tire according to any one of [1] to [6], wherein each of the plurality of grooves has a groove width of 3 to 10 mm at the outer peripheral surface and a groove depth of 1 to 10 mm.
[8]

The pneumatic tire according to any one of [1] to [7], wherein each of the plurality of grooves extends at an angle of 1 to 90° with respect to a tire circumferential direction.
[9]

The pneumatic tire according to any one of [1] to [8], wherein each of the plurality of grooves extends in parallel to a tire circumferential direction.
[10]

The pneumatic tire according to any one of [1] to [9], wherein
the sound absorbing member has a pair of end surfaces in the tire circumferential direction, and
a space is formed between the pair of end surfaces.
[11]

The pneumatic tire according to any one of [1] to [10], wherein at least one of the pair of end surfaces has a tapered surface whose height in the tire radial direction gradually becomes smaller.
[12]

A pneumatic tire comprising:
a tread portion; and
a sound absorber on an inner surface of the tread portion,
wherein the sound absorber defines an outer peripheral surface facing outward in a tire radial direction and an inner peripheral surface facing inward in the tire radial direction,
wherein the sound absorber includes:
a plurality of grooves, which extend from a first side of the sound absorber to a second side of the sound absorber, on the outer peripheral surface, and
a plurality of land portions, which extend from the first side of the sound absorber to the second side of the sound absorber, on the outer peripheral surface, the plurality of land portions being separated from each other by respective ones of the plurality of grooves,
wherein each of the plurality of land portions is fixedly attached to the inner surface of the tread portion continuously along a longitudinal direction of the plurality of grooves,
wherein a maximum thickness of the sound absorber is less than a maximum depth of the plurality of grooves,
wherein a cross-section of each of the plurality of grooves is the same,
wherein a valley portion of each of the plurality of grooves is flat, and
wherein the grooves are open at each of the first side of the sound absorber and the second side of the sound absorber.
[13]

The pneumatic tire according to [12], wherein the first side of the sound absorber is a first end of the sound absorber, and the second side of the sound absorber is a second end of the sound absorber opposite the first end in the longitudinal direction of the plurality of grooves.
[14]

The pneumatic tire according to [12] or [13], wherein a first width of at least some of the plurality of grooves is the same as a second width of at least some of the plurality of land portions.
[15]

The pneumatic tire according to any one of [12] to [14], wherein no portion of each of the plurality of grooves is directly fixedly attached to the inner surface of the tread portion.

What is claimed is:

1. A pneumatic tire comprising a tread portion, wherein
a sound absorbing member is on an inner surface of the tread portion,
the sound absorbing member has an outer peripheral surface facing outward in a tire radial direction,
a plurality of grooves, and a plurality of land portions separated from each other by the plurality of grooves, are formed in the outer peripheral surface of the sound absorbing member, and
each of the plurality of land portions is fixedly attached to the inner surface continuously along a longitudinal direction of the plurality of grooves.

2. The pneumatic tire according to claim 1, wherein an attached area of the plurality of land portions to the inner surface of the tread portion is 25% to 50% of a projected area of the sound absorbing member onto the inner surface of the tread member.

3. The pneumatic tire according to claim 1, wherein each of the plurality of grooves has a cross-sectional shape the same as each other, in a cross-section thereof perpendicular to the longitudinal direction of the plurality of grooves.

4. The pneumatic tire according to claim 3, wherein
each of the plurality of land portions is fixedly attached to the inner surface over widths that are equal to each other, in the cross-section, and
each of the widths is equal to a groove width of each of the plurality of grooves at the outer peripheral surface of the sound absorbing member.

5. The pneumatic tire according to claim 1, wherein
each of the plurality of grooves has a pair of groove walls, and
each of the pair of groove walls has a wall surface perpendicular to the outer peripheral surface of the sound absorbing member.

6. The pneumatic tire according to claim 5, wherein a chamfered portion is formed at each corner portion between the wall surfaces and the outer peripheral surface of the sound absorbing member.

7. The pneumatic tire according to claim 1, wherein each of the plurality of grooves has a groove width of 3 to 10 mm at the outer peripheral surface of the sound absorbing member and a groove depth of 1 to 10 mm.

8. The pneumatic tire according to claim 1, wherein each of the plurality of grooves extends at an angle of 1 to 900 with respect to a tire circumferential direction.

9. The pneumatic tire according to claim 1, wherein each of the plurality of grooves extends in parallel to a tire circumferential direction.

10. The pneumatic tire according to claim 1, wherein
the sound absorbing member has a pair of end surfaces in the tire circumferential direction, and
a space is formed between the pair of end surfaces.

11. The pneumatic tire according to claim 10, wherein at least one of the pair of end surfaces has a tapered surface whose height in the tire radial direction gradually becomes smaller.

12. A pneumatic tire comprising:
a tread portion; and
a sound absorber on an inner surface of the tread portion,
wherein the sound absorber defines an outer peripheral surface facing outward in a tire radial direction and an inner peripheral surface facing inward in the tire radial direction,
wherein the sound absorber includes:
a plurality of grooves, which extend from a first side of the sound absorber to a second side of the sound absorber, on the outer peripheral surface, and
a plurality of land portions, which extend from the first side of the sound absorber to the second side of the sound absorber, on the outer peripheral surface, the plurality of land portions being separated from each other by respective ones of the plurality of grooves,
wherein each of the plurality of land portions is fixedly attached to the inner surface of the tread portion continuously along a longitudinal direction of the plurality of grooves,
wherein a maximum thickness of the sound absorber is less than a maximum depth of the plurality of grooves,
wherein a cross-section of each of the plurality of grooves is the same,
wherein a valley portion of each of the plurality of grooves is flat, and
wherein the grooves are open at each of the first side of the sound absorber and the second side of the sound absorber.

13. The pneumatic tire according to claim 12, wherein the first side of the sound absorber is a first end of the sound absorber, and the second side of the sound absorber is a second end of the sound absorber opposite the first end in the longitudinal direction of the plurality of grooves.

14. The pneumatic tire according to claim 12, wherein a first width of at least some of the plurality of grooves is the same as a second width of at least some of the plurality of land portions.

15. The pneumatic tire according to claim 12, wherein no portion of each of the plurality of grooves is directly fixedly attached to the inner surface of the tread portion.
